(19) United States
(12) Patent Application Publication
(10) Pub. No.: US 2010/0122542 A1
(43) Pub. Date: May 20, 2010

(54) METHOD AND APPARATUS FOR ADJUSTING HEATING VALUE OF NATURAL GAS

(75) Inventors: Dong Kyu Choi, Geoje-si (KR); Young Sik Moon, Geoje-si (KR); Jae Wan Ahn, Geoje-si (KR); Jung Han Lee, Geoje-si (KR); Jae Ryu Bae, Geoje-si (KR)

Correspondence Address: KNOBBE MARTENS OLSON & BEAR LLP, 2040 MAIN STREET, FOURTEENTH FLOOR, IRVINE, CA, 92614, US

(73) Assignee: DAEWOO SHIPBUILDING & MARINE ENGINEERING CO., LTD., SEOUL (KR)

(21) Appl. No.: 12/556,418

(22) Filed: Sep. 9, 2009

(30) Foreign Application Priority Data
Nov. 17, 2008 (KR) 10-2008-0113994
Dec. 26, 2008 (KR) 10-2008-0134248
Apr. 6, 2009 (KR) 10-2009-0029212

(51) Int. Cl. F17C 9/02; F17C 13/08

(52) U.S. Cl. 62/50.5; 62/50.2; 62/53.2; 62/620

(57) ABSTRACT

Disclosed is a method and apparatus for adjusting heating value of natural gas, wherein components having high heating value are separated from natural gas consisting of various hydrocarbon components to reduce heating value of natural gas supplied to the markets. The method includes heating liquefied natural gas (LNG), separating the LNG heated and partially gasified into a gaseous component having low heating value and a liquid component having high heating value.

### CROSS-REFERENCE TO RELATED APPLICATION

This application claims priority to and the benefit of Korean Patent Application Nos. 10-2008-0113994, 10-2008-0134248 and 10-2009-0029212, filed Nov. 17, 2008, Dec. 26, 2008 and Apr. 6, 2009, respectively, the disclosures of which are incorporated herein by reference in their entirety.

### BACKGROUND

1. Field

The present disclosure relates to a method and apparatus for adjusting heating value of natural gas prior to supplying it to the markets.

2. Description of the Related Technology

In recent, the amount of consumption of natural gas has been increased rapidly throughout the world. Natural gas which is in a gas state is transported through a gas pipe line installed on the land or in the sea, or natural gas which is in a liquefied natural gas (LNG) state is transported by an LNG carrier (LNG transport vessel) to distant the markets while the liquefied natural gas is stored in the LNG carrier. Liquefied natural gas is produced by cooling natural gas at an extremely low temperature of approximately −163° C., and a volume of the liquefied natural gas is approximately 1/600 of a volume of natural gas which is in a gas state, so that marine transportation is suitable for a long-distance transportation of liquefied natural gas.

The LNG transport vessel is employed for loading LNG, sailing on the sea and unloading LNG to a land the market. In order to perform the above functions, the LNG transport vessel comprises an LNG storage tank (generally referred to as a cargo containment) which can withstand extremely low temperature of LNG. In general, LNG stored in the LNG storage tank of the LNG transport vessel is unloaded to land in a liquid state, and the LNG unloaded on land is re-gasified in an LNG re-gasification facility installed on the land. Re-gasified natural gas is then transported to the markets via gas lines.

It has been well known that it is advantageous to install the LNG re-gasification facility at a region where the market for natural gas is formed and natural gas is in stable demand. In the natural gas the market where a demand for natural gas is varied seasonally, periodically and in a short term, however, it is extremely economically disadvantageous to provide the LNG re-gasification facility on land due to a high installation and management expense.

In particular, a method for transporting natural gas using a typical LNG transport vessel has a limitation in that when the LNG re-gasification facility provided on land is damaged by natural disasters, LNG cannot be re-gasified in the LNG re-gasification facility although the LNG transport vessel in which LNG is loaded arrives at the market.

Accordingly, a marine LNG re-gasification system has been developed, in which an LNG re-gasification facility is provided on an LNG transport vessel or a marine floating structure to re-gasify natural gas on a sea and natural gas generated by a re-gasification process is supplied to land. The marine structure equipped with a re-gasification facility may include an LNG regasification vessel (LNG RV) or an LNG floating storage and regasification unit (LNG FSRU), for example.

In the meantime, natural gas which is re-gasified and supplied to the markets should be supplied in a state where heating value of natural gas is adjusted according to the region at which natural gas is consumed. If the heating value of the LNG which is transferred to the market is higher than the standard heating value required by the market, an appropriate amount of nitrogen gas should be mixed or components having high heating value should be further removed. In addition, there is a problem in that if the heating value of the LNG which is transferred to the market is lower than the standard heating value required by the market, an liquefied petroleum gas (LPG) component (a hydrocarbon component having high heating value) which was separated prior to the transportation should be mixed again.

As described above, the method for reducing heating value of natural gas includes a method for adding inert gas such as nitrogen and a method for separating a component having high heating value, while the method for increasing heating value of natural gas includes a method for adding a component having high heating value.

In general, heating value of natural gas which is immediately produced is higher than the standard heating value required by the market, so that the method for reducing heating value has been used mainly when heating value of natural gas is adjusted. In the method for separating a component having high heating value from natural gas as the method for reducing heating value of natural gas, hydrocarbon components (ethane, propane, butane and the like) having high heating value in the various hydrocarbon components, i.e., methane (C₁), ethane, propane and butane (C₂˜C₄), contained in natural gas are separated. Such method is disclosed in U.S. Pat. Nos. 2,952,984, 3,282,060, 3,407,052 and the like. In addition, the method for adding nitrogen to natural gas to reduce heating value is disclosed in U.S. Pat. No. 3,837,821 and the like.

The foregoing discussion in this section is to provide general background information, and does not constitute an admission of prior art.

### SUMMARY

One aspect of the invention provides an LNG heating value adjustment system. The system comprises: an LNG tank containing liquefied natural gas (LNG), the LNG tank comprising an LNG tank outlet and an LNG tank inlet; a conduit connected to the outlet of the LNG tank and configured to flow LNG from the LNG tank therethrough; a heater configured to heat the LNG flowing through the conduit to a predetermined temperature to boil off some of the LNG boils to form a mixture of gaseous components and liquid components; and a gas-liquid separator, which is not a distillation column, comprising an enclosed space, a gas outlet and a liquid outlet: to receive the mixture from the conduit, wherein a phase separation occurs between the liquid components and gaseous components as the mixture enters the enclosed space of the gas-liquid separator, to discharge the gaseous components via the gas outlet, and to discharge the liquid components via the liquid outlet.

In the foregoing system, the liquid outlet may be connected to the LNG tank directly or indirectly such that all or some of the liquid components are returned to the LNG tank. The conduit may be configured to continuously flow the LNG, and the gas-liquid separator may be configured to continuously receive the mixture and to continuously discharge the gaseous components and liquid components. The system may further comprise: a pre-heater located upstream the heater in the conduit, the pre-heater being configured to pre-heat the LNG using heat from the gaseous components discharged from the gas-liquid separator. The system may further comprise: a distillation column configured to receive all or some of the liquid components from the gas-liquid separator and to separate one or more components therefrom. The system may further comprise: another LNG tank configured to receive all or some of the liquid components discharged from the gas-liquid separator. A floating structure may comprise the foregoing system.

Another aspect of the invention provides a method of adjusting a heating value of LNG. The method comprises: providing an LNG tank containing liquefied natural gas (LNG); discharging LNG from the LNG tank and flowing through a conduit; heating the LNG flowing through a conduit to a predetermined temperature to boil off some of the LNG so as to form a mixture of liquid components and gaseous components; supplying the mixture into a gas-liquid separator comprising an enclosed space, which is not a distillation column, wherein a phase separation occurs between the liquid components and gaseous components as the mixture enters the enclosed space of the gas-liquid separator; discharging the gaseous components from the gas-liquid separator; and discharging the liquid components from the gas-liquid separator.

The foregoing method may further comprise returning all or some of the liquid components to the LNG tank, whereby a heating value of the LNG contained in the LNG tank may be adjusted. The method may further comprise collecting all or some of the liquid components in another LNG tank. The method may further comprise continuously supplying all or some of the liquid components to a distillation column for separating one or more components therefrom. The method may further comprise pre-heating the LNG flowing through the conduit using heat from the gaseous components discharged from the gas-liquid separator. In the foregoing method, LNG may be continuously discharged from the LNG tank and continuously flown through the conduit. The mixture may be continuously supplied into the gas-liquid separator, wherein the gaseous components may be continuously discharged from the gas-liquid separator, and wherein the liquid components may be continuously discharged from the gas-liquid separator. The method may further comprise collecting the gaseous components in a natural gas (NG) container. The method may be performed on board in a ship. The method may be performed on an off-shore floating structure or an on-shore facility.

An aspect of the present invention provides a method and apparatus for reducing heating value of natural gas, wherein some of components having high heating value is separated using a separator to meet standard heating value required by the markets in order to reduce heating value of natural gas consisting of various hydrocarbon components according to requirement of the markets, whereby a scale of the entire facility can be simplified and an operation expense can be reduced.

According to an aspect of the present invention for achieving the objects, there is provided an apparatus for reducing heating value of natural gas, which comprises a heating means for heating LNG; and a gas-liquid separating means for separating the LNG heated and partially gasified by the heating means into a gaseous component having low heating value and a liquid component having high heating value.

Preferably, the heating means is at least one of a heater and a heat exchanger. A heat source for heating the LNG in the heat exchanger is preferably supplied from the gas component separated in the gas-liquid separating means. Preferably, the apparatus further comprises a small-sized distillation column for secondarily separating the liquid component primarily separated in the gas-liquid separating means into a component having low heating value and a component having high heating value. The component having low heating value secondarily separated in the small-sized distillation column is preferably mixed with the component having low heating value primarily separated in the gas-liquid separating means. The component having high heating value secondarily separated in the small-sized distillation column is preferably stored in an additional storage tank or used as fuel. The gaseous component having low heating value separated in the gas-liquid separating means is preferably heat-exchanged with the LNG in the heat exchanger to be cooled and liquefied.

Preferably, the apparatus further comprises a gasifier for being supplied with the component having low heating value liquefied in the heat exchanger by a high pressure pump, gasifying the component having low heating value, and then supplying the gasified component to a market. Nitrogen is preferably mixed with the component having low heating value separated in the gas-liquid separating means to reduce heating value thereof.

Preferably, the apparatus further comprises a bypass line for allowing a portion of the LNG supplied to the gas-liquid separating means to bypass the gas-liquid separating means and to be mixed with the component having low heating value separated in the gas-liquid separating means. The bypass line is preferably arranged to pass through the heat exchanger in which the LNG supplied to the heating means is heat-exchanged with the component having low heating value separated in the gas-liquid separating means.

Preferably, the apparatus further comprises another small-sized distillation column for further separating the component having high heating value separated in the small-sized distillation column, the small-sized distillation columns being installed in succession. Preferably, the apparatus further comprises a storing means for accommodating the liquid component having high heating value separated in the gas-liquid separating means. Preferably, the storing means is one of a plurality of LNG storage tanks which store the LNG to be supplied to the gas-liquid separating means. Preferably, the storing means is one of a storage tank installed on a deck and a storage tank installed in a hull. Preferably, the storing means is one of a membrane type tank, an independent type tank, and a pressure vessel. The liquid component having high heating value separated in the gas-liquid separating means is preferably expanded to normal pressure in an expansion valve and then stored in the storing means.

Preferably, the liquid component having high heating value separated in the gas-liquid separating means is heated by a heater and then stored in the storing means. Boil off gas naturally evaporated in the storing means is discharged from the storing means and then mixed with the gaseous component having low heating value separated in the gas-liquid separating means. The boil off gas is heat-exchanged with the LNG in a heat exchanger to be cooled and liquefied.

According to another aspect of the present invention, there is provided a floating marine structure floating on a sea, which comprises an LNG storage tank; an LNG re-gasification equipment; and the apparatus for reducing heating value of natural gas as described above. Preferably, the floating marine structure is one selected from an LNG RV and an LNG FRSU.

According to a further aspect of the present invention, there is provided a method for reducing heating value of natural gas, which comprises the steps of heating LNG; and separating the LNG partially gasified through the heating step into a gaseous component having low heating value and a liquid component having high heating value through a gas-liquid separating means.

Preferably, the method further comprises the step of distilling and separating more precisely the liquid component having high heating value separated through the gas-liquid separating means. Preferably, the method further comprises the step of expanding the liquid component having high heating value in a storing means.

### BRIEF DESCRIPTION OF THE DRAWINGS

FIG. 1 is a schematic view of an apparatus for reducing heating value of natural gas according to an embodiment of the present invention;

FIG. 2 is a schematic view of an apparatus for reducing heating value of natural gas according to an embodiment of the present invention;

FIG. 3 is a schematic view of an apparatus for reducing heating value of natural gas according to an embodiment of the present invention;

FIG. 4 is a schematic view of an apparatus for reducing heating value of natural gas according to a embodiment of the present invention; and

FIG. 5 is a schematic view of an apparatus for reducing heating value of natural gas according to an embodiment of the present invention.

### DESCRIPTION OF EMBODIMENTS

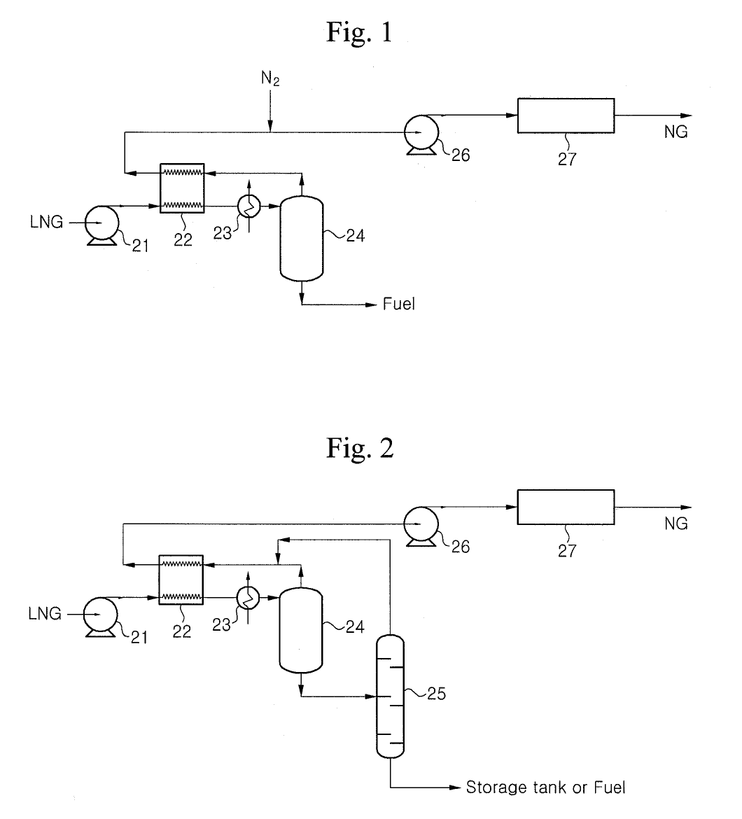

Hereinafter, a method and apparatus for adjusting or reducing heating value of natural gas according to embodiments of the present invention will be described in detail with reference to the accompanying drawings. FIGS. 1 to 5 are schematic views for illustrating methods and apparatuses for reducing heating value of natural gas according to embodiments of the present invention.

Generally, if only the method for adding nitrogen is used to reduce heating value of natural gas, there may be a problem in that a ratio of nitrogen in the components constituting natural gas supplied to the markets is increased excessively. In general, it is desirable to maintain a ratio of nitrogen in natural gas within a range of less than 3%. Further, in a case where the method is performed on the marine structure such as an LNG FSRU since the amount of consumed nitrogen is excessive, there may be a problem in that nitrogen is not supplied smoothly, or an operating expense of the facility is increased since nitrogen should be produced directly and consumed on the sea.

In addition, if only the method for separating a component (for example, ethane, propane, butane and the like) having high heating valve from natural gas is used for reducing heating value of natural gas, a large-sized distillation column for separating the component having high heating value, an additional storage tank capable of storing the separated component in a liquid state, and various equipments related thereto should be provided additionally, so that a scale of the entire facility is increased and the operation of the facility becomes complicated.

The method for reducing heating value of natural gas according to one embodiment of the present invention comprises the steps of partially separating components having high heating value from liquid natural gas (LNG) using a separator during the re-gasification of LNG, which is produced at a gas well, liquefied and then transported, and the supply of LNG to the markets, and adding nitrogen to LNG for adjusting heating value of LNG to standard heating value required by the market.

As shown in FIG. 1, LNG transferred from a storage tank (not shown) is pressurized with low pressure by an LNG transferring pump 21 and then supplied to a heat exchanger 22. The LNG is primarily heated while passing through the heat exchanger 22. At this time, since the LNG is heated in the heat exchanger 22, the LNG can be partially gasified. The LNG primarily heated in the heat exchanger 22 is continuously supplied to a heater 23. The LNG is heated in the heater 23, thereby being partially gasified. Then, the LNG is supplied to a separator 24.

Although FIG. 1 shows that LNG is partially gasified and then supplied to the separator, natural gas which is naturally or artificially gasified may be partially condensed and then supplied to a separator.

The components gasified by heat supplied from the heater 23 are components having low heating value (mostly, methane). In general, the lower the heating value is, that is, the smaller the number of carbon atoms in a carbon molecule is, the lower liquefaction temperature is, so that gasification is first generated.

LNG, in which the components having low heating value are gasified in the heater 23 and thus gas and liquid are mixed, is divided into gaseous components and liquid components in the separator 24. Subsequently, liquid components, that is, components having high heating value are supplied to a storage tank (not shown) and then stored therein or used as fuel of a propelling device, a power generator and the like.

According to one embodiment of the present invention, all of the liquid components separated in the separator 24 are used as fuel of a power generator and the like. To this end, the temperature of the heater 23 can be adjusted so that only the liquid components as mush as the necessary amount of fuel may be separated in the separator 24. That is, in one embodiment of the present invention, all of the components having high heating value are not separated from LNG until the heating value is adjusted to the value required by the market, but only the components as much as used as fuel may be separated from LNG.

According to one embodiment of the present invention as described above, a portion of the components having high heating value is separated from natural gas, and then, all of the separated components may be consumed as fuel for a power generator and the like. Accordingly, it is unnecessary to provide an additional storage tank for storing the liquid components separated from natural gas or equipments related thereto.

Further, generally speaking, in order to separate and sell the components having high heating value, i.e., the components such as butane and propane have been separated and sold in the name of liquefied petroleum gas (LPG), there is need to precisely separate the LPG component and an equipment such as a column has been used for the separation. According to one embodiment of the present invention, however, since the components having high heating value are separated and then burned as fuel for the power generator and the like for using it internally, there is no need to separate only the components such as butane, propane and the like. Accordingly, there is an advantage in that the components having high heating value can be separated by means of the separator 24 which is relatively simple equipment.

In the meantime, after the liquid components are separated in the separator 24, the rest gaseous components are supplied to the heat-exchanger 22 and then condensed. Cold energy required for condensing the gaseous components can be obtained from the LNG supplied from the LNG storage tank to the heat exchanger 22 by the LNG transferring pump 21. According to one embodiment of the present invention, since the gaseous components separated in the separator 24 can be cooled and condensed by the heat exchange between the gaseous components and the LNG in the heat exchanger 22, the liquid can be transferred through the pump. As a result, compared with the transfer of the gaseous components by a compressor, the transferring operation can be performed more effectively and inexpensively, thereby reducing the energy consumption.

Because the components having high heating value are partially separated from the LNG condensed in the heat exchanger 22, total heating value of the LNG is somewhat lowered. However, the heating value of the LNG may be higher than standard heating value required by the market. Accordingly, nitrogen may be added into the LNG so as to adjust the heating value of the LNG to the standard heating value required by the market.

Either gaseous or liquid nitrogen may be used as the nitrogen to be added. In a case where gaseous nitrogen is added, a nitrogen adding means for adding nitrogen may comprise a nitrogen absorbing device (not shown) for allowing gaseous nitrogen to be absorbed into liquid-phased LNG, a nitrogen valve (not shown) for adjusting the amount of nitrogen to be added, and the like. In addition, when liquid nitrogen is added, a nitrogen adding means for adding nitrogen may comprise a nitrogen mixing device (not shown) for mixing liquid nitrogen with liquid-phased LNG, a nitrogen valve (not shown) for adjusting the amount of nitrogen to be added, and the like. The amount of nitrogen to be added can be adjusted precisely in such a manner that opening/closing of the nitrogen valve is controlled by a controller which is not shown.

As the aforementioned nitrogen absorbing device, nitrogen mixing device and nitrogen valve, what has any configuration for adding nitrogen into LNG may be used.

According to one embodiment of the present invention, the considerably small amount of nitrogen is added as compared with the prior art in which heating value is adjusted only by adding nitrogen, so that the consumption of nitrogen can be remarkably reduced. There is an excellent effect in that on the sea on which nitrogen is not supplied smoothly, there is no need to additionally provide a nitrogen generation equipment for producing nitrogen or the heating value adjusting operation can be sufficiently performed only by a nitrogen generation equipment with a small capacity. As described above, it is possible to reduce the consumption of expensive nitrogen and thus to save an operating expense of facilities.

Continuously, the LNG of which the heating value is adjusted by adding nitrogen is pressurized with high pressure by a high pressure pump 26, gasified in an LNG gasifier 27, and then supplied to the final the markets.

Hereinafter, the method and apparatus for reducing heating value of natural gas according to some embodiments of the present invention will be described with reference to FIG. 2 to FIG. 5.

The method for reducing heating value of natural gas according to embodiments of the present invention comprises the step of partially gasifying LNG to partially separate components having high heating value therefrom during the re-gasification of LNG, which is produced at a gas well, liquefied and then transported, and the supply of LNG to the markets.

Although the apparatus and method for reducing heating value of natural gas according to one embodiment of the present invention separates components having high heating value and then add s nitrogen to adjust heating value to value required by the market, the apparatus and method for reducing heating value of natural gas according to embodiments of the present invention separates components having high heating value to adjust heating value to value required by the market and adds no nitrogen.

Hereinafter, an apparatus for reducing heating value of natural gas according to one embodiment of the present invention will be described with reference to FIG. 2. In FIG. 2, for convenience, the components which are the same as or similar to those of the apparatus for reducing heating value of natural gas according to one embodiment are designated by the same reference numerals and the detail description thereon will be omitted.

As shown in FIG. 2, LNG discharged from the storage tank is supplied to the heater 23 by the LNG transferring pump 21. The transferred LNG is heated and partially gasified in the heater 23 and then supplied to the separator 24. The heat exchanger 22 may be provided between the LNG transferring pump 21 and the heater 23.

The components gasified by heat supplied from the heater 23 are components having low heating value (mostly, methane). In general, the lower the heating value is, that is, the smaller the number of carbon atoms in a carbon molecule is, the lower liquefaction temperature is, so that gasification is first generated.

LNG, in which the components having low heating value are gasified in the heater 23 and thus gas and liquid are mixed, is divided into gaseous components and liquid components in the separator 24. Subsequently, liquid components, that is, components having high heating value are supplied to a storage tank (not shown) and then stored therein or used as fuel.

According to one embodiment of the present invention, a small-sized distillation column 25 may be used in order to separate more precisely the liquid components. At this time, the small-sized distillation column 25 is to secondarily separate the components which are primarily separated in the separator 24, and the inexpensive and small-sized distillation column may be employed without the need to use an expensive and large-sized distillation column which should have been used in a conventional case where hydrocarbon components are separated using only a distillation column.

In other words, since most (approximately 90% or more) of the components having low heating value contained in LNG were primarily and already separated in the separator 24, the treated amount in the distillation column 25 is reduced to less than approximately 10%. Accordingly, it is possible to remarkably reduce a scale, a treatment capacity and the like of the small-sized distillation column 25, so that an initial investment and an operating expense can be reduced. In the meantime, if cold energy of LNG is used in the separation process in the small-sized distillation column 25, an operating expense can be reduced.

The components having low heating value secondarily separated in the small-sized distillation column 25 are mixed with the gaseous components which are already separated in the separator 24, and then, can be transferred for the next process. The components having low heating value separated from LNG in the separator 24 and the small-sized distillation column 25 are supplied to the heat exchanger 22 and heat-exchanged with LNG that is supplied from the LNG storage tank to the heater 23, thereby heating the LNG and being cooled and liquefied.

Prior to the supply of the LNG to the heater 23, the LNG is heated in the heat exchanger 22, so that the energy consumption in the heater 23 can be reduced (that is, the capacity of the heater can be reduced). Further, the components having low heating value are cooled and liquefied in the heat exchanger 22, so that the high pressure pump 26 can be used to transfer the liquid component, which can thus reduce power as compared with a method in which gas components are transferred by a compressor.

The components having low heating value, which are already cooled and liquefied through the heat exchanger 22, are supplied to the gasifier 27 by the high pressure pump 26 and then gasified in the gasifier 27, whereby the gasified components can be supplied to the markets in a natural gas state.

According to one embodiment of the present invention as described above, the components having low heating value and the components having high heating value can be separated from each other by the separator 24. In addition, the small-sized distillation column 25 is additionally provided to separate more precisely the components having high heating value from LNG, if necessary, whereby the demand for heating value of LNG required by the market can be satisfied without adding nitrogen.

In addition, as in the aforementioned embodiment, the components having high heating value separated in the separator 24 and the small-sized distillation column 25 may be consumed as fuel for a power generator and the like. In this case, if the consumption of fuel is sufficiently larger than separated high heating value components, it may be unnecessary to provide an additional storage tank or related equipments for storing the separated liquid components, i.e., components having high heating value. It will be apparent that the separated liquid components are not used as fuel, but may be stored in an additional storage tank and then sold after a subsequent treatment.

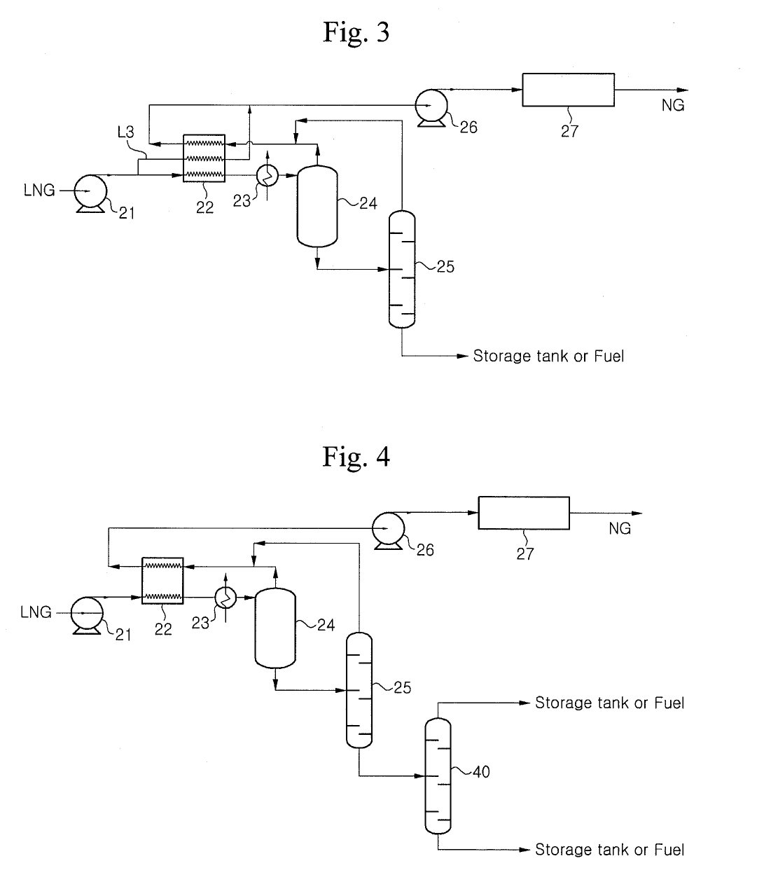

FIG. 3 schematically illustrates the apparatus for reducing heating value of natural gas according to one embodiment of the present invention.

The apparatus for reducing heating value of natural gas according to one embodiment is generally similar to that of the aforementioned embodiment. The apparatus of this embodiment is different from the apparatus of one embodiment only in that the apparatus of this embodiment comprises a bypass line L3 provided for allowing a portion of the LNG, which is supplied from the LNG storage tank to the separator 24, to bypass the separator 24 toward a downstream side of the separator 24. In FIG. 3, for convenience, the components which are the same as or similar to those of the apparatus for reducing heating value of natural gas according to one embodiment are designated by the same reference numerals and the detail description thereon will be omitted.

The bypass line L3 branches off from a supply line through which LNG is supplied from the LNG storage tank to the separator 24. More specifically, the bypass line L3 branches off from a portion of the supply line at an upstream side of the heat exchanger 22. The branching bypass line L3 passes through the heat exchanger and then is connected, at an upstream side of the high pressure pump 26, to a discharging line, through which the gaseous components separated in the separator 24 are transferred after being liquefied while passing through the heat exchanger 22. Accordingly, the LNG discharged from the LNG storage tank bypasses the separator 24 toward the high pressure pump 26 through the bypass line L3 in a state where the components having high heating value are not separated therefrom.

According to one embodiment, the amount of LNG to be treated in the separator 24 may be reduced due to the bypass line L3. Accordingly, the gaseous components, i.e., the components having low heating value separated in the separator 24 are heat-exchanged with the LNG, which is supplied from the LNG storage tank to the separator 24, in the heat exchanger 22, so that the amount of the gaseous components to be liquefied can be reduced when the gaseous components are liquefied. Due to the reduction of the amount of the gaseous components to be liquefied, it is possible to liquefy more easily the gaseous components in the heat exchanger 22.

According to one embodiment of the present invention, in a case where the liquefaction of the gaseous components is not satisfactory in the heat exchanger 22, a portion of the LNG bypasses the separator 24 through the bypass line L3, so that the gaseous components separated in the separator 24 (and the small-sized distillation column 25) can be liquefied satisfactorily in the heat exchanger 22.

In addition, according to one embodiment of the present invention, since the amount of the components having high heating value to be treated in the separator 24 and the small-sized distillation column 25 is reduced, the treatment capacity of the related equipments including the separator 24 and the small-sized distillation column 25 can be reduced, so that the apparatus can be miniaturized and the consumption of energy can be reduced.

FIG. 4 schematically illustrates the apparatus for reducing heating value of natural gas according to one embodiment of the present invention.

The apparatus for reducing heating value of natural gas according to one embodiment is generally similar to that of the aforementioned embodiment. The apparatus of this embodiment is different from the apparatus of one embodiment only in that the small-sized distillation column 25 and another small-sized distillation column 40 are installed in succession in the apparatus of this embodiment. In FIG. 4, for convenience, the components which are the same as or similar to those of the apparatus for reducing heating value of natural gas according to one embodiment are designated by the same reference numerals and the detail description thereon will be omitted.

When a hydrocarbon component should be separated precisely for sale, the small-sized distillation columns 25 and 40 may be installed in succession as shown in FIG. 4, thereby precisely separating LNG. Although FIG. 4 exemplarily shows that the two small-sized distillation columns 25 and 40 are used, two or more small-sized distillation columns may be used, if necessary.

As shown in FIG. 4, in the components separated in the second small-sized distillation column 40, the components separated at a lower end of the small-sized distillation column 40 can be stored in an additional storage tank (not shown) or used as fuel for a power generator and the like. In addition, the components separated at an upper end of the small-sized distillation column 40, i.e., the gaseous components can be heat-exchanged with the LNG stored in the LNG storage tank, and then cooled and liquefied. Then, this liquefied component can be stored in a storage tank (not shown) or used as fuel. After the components are precisely separated, each hydrocarbon component stored in the storage tank may be sold or used as fuel after a subsequent process.

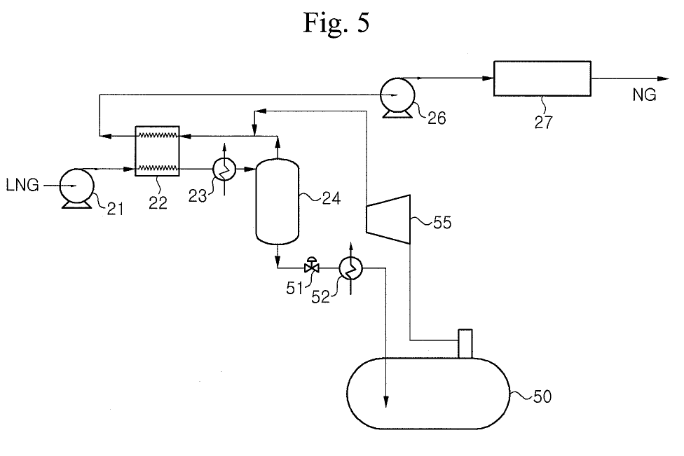

FIG. 5 schematically illustrates the apparatus for reducing heating value of natural gas according to one embodiment of the present invention.

In the apparatus for reducing heating value of natural gas according to one embodiment, the liquid components separated in the separator 24, i.e., the components having high heating value are not separated additionally in the small-sized distillation column, but are stored as they are in the additional storage tank 50 with appropriate temperature and pressure. Thus, the heating value can be additionally adjusted by the vapor-liquid separation in this additional storage tank. As described above, the apparatus for reducing heating value of natural gas according to one embodiment is generally similar to that of the aforementioned embodiment. The apparatus of this embodiment is different from the apparatus of one embodiment only in that the apparatus of this embodiment uses the additional storage tank 50 as a secondary separator. In FIG. 5, for convenience, the components which are the same as or similar to those of the apparatus for reducing heating value of natural gas according to one embodiment are designated by the same reference numerals and the detail description thereon will be omitted.

According to one embodiment, the liquid components separated in the separator 24 are expanded to normal pressure by an expansion valve 51 and then stored in the additional storage tank 50. Before being stored in the storage tank 50, the liquid components may be preferably heated by another heater 52, if necessary.

As the storage tank 50 for storing the liquid components separated in the separator 24, one of a plurality of storage tanks (e.g., membrane tanks), which are already installed to a floating structure and the like to be mounted with the apparatus for reducing heating value according to embodiments of the present invention, may be used.

Alternatively, as the storage tank 50 for storing the liquid components separated in the separator 24, one of tanks installed on a deck of the floating marine structure may be used, or one of tanks (e.g., MOSS type tanks, SPB type tanks, and the like) installed in a hull of the floating marine structure.

According to one embodiment, the storage tank 50 for storing the liquid components separated in the separator 24 can also function as another separator. The storage tank may be one of membrane tanks, independent tanks, and pressure vessels, if the tanks or vessels can be installed on a deck or in a hull of the floating marine structure so as to store liquefied gas.

The liquid components separated primarily in the separator 24 are continuously expanded and heated to appropriate temperature and pressure and then transferred to the additional storage tank 50. In the liquid components primarily separated, the components having low heating value are gasified during the expansion and heating processes and then separated secondarily in the storage tank 50. The gaseous components having low heating value secondarily separated are transferred by a compressor 55, mixed with the gaseous components separated primarily in the separator 24, and then cooled and liquefied in the heat exchanger 22. As described above, the additional storage tank 50 functions as another separator, i.e., a gas-liquid separating means, thereby enabling the gaseous components having relatively low heating value and the liquid components having relatively high heating value to be separated secondarily.

Boil off gas (BOG) generated in the additional storage tank 50 can be discharged to the outside, compressed and transferred by the compressor 55, and then mixed with the gaseous components separated in the separator 24. As described above, the components having low heating value are gasified at relatively low temperature as compared with the components having high heating value, so that the BOG generated in the additional storage tank 50 may be regarded as a component having low heating value.

As described above, according to embodiments of the present invention, without adding nitrogen into LNG or using an expensive large-sized distillation column for reducing heating value in the LNG regasification facility, almost of components having low heating value can be separated easily using the separator to thereby considerably reduce the amount of the components having high heating value to be additionally treated to 10% or less of an initial supply. Accordingly, a scale of the additional distillation facility can be remarkably reduced, thereby reduce an investment and operation expense.

In a case where there is no need to perform an additional distillation process, the components having high heating value separated primarily in the separator are expanded to normal pressure and heated and then stored in the separated storage tank, so that the gaseous components having low heating value and the liquid components having high heating value can be further separated in this additional storage tank to ultimately adjust the heating value. Simultaneously, the liquid components having high heating value can be stored.

According to embodiments of the present invention as described above, since the separator is used to satisfy the conditions of heating value, almost of LNG can be treated (that is, gasified and then supplied to the markets).

In addition, the heat exchange of the gaseous components separated in the separator with LNG makes it possible to reduce the capacity of the heater. Further, the gaseous components separated in the separator are heat-exchanged with LNG and then liquefied, thereby allowing the high pressure pump 26 to be used, which makes it possible to reduce the consumption of power as compared with the method in which the gaseous components are transferred by a compressor.

Further, BOG that is gas having low heating value separated in the LNG storage tank can be liquefied by and mixed with LNG in a re-condenser or liquefied with separated light component gas at the aforementioned heat exchanger 22, gasified in the gasifier, and then, supplied to the market. The gaseous components separated in the small-sized distillation column can be heat-exchanged with LNG and then liquefied to thereby achieve a process having the fairly high efficiency.

Furthermore, although the heater 23 and the separator 24 are independent illustrated in FIGS. 1 to 5, they may be modified so that the heater 23 is mounted integrally within the separator 24.

The apparatus for reducing heating value of natural gas according to embodiments of the present invention as described above may be used in a marine structure, where nitrogen is not supplied stably, such as an LNG RV, an LNG FRSU and the like. In the LNG RV, an LNG regasification facility is installed on an LNG transport vessel which can be self-propelled and float on the sea. Also, the LNG FRSU is a floating marine structure for storing LNG unloaded from the LNG transport vessel in a storage tank on the sea far away from land, gasifying the stored LNG according to a demand and supplying the gasified LNG to the land markets.

It will be apparent that the apparatus for reducing heating value of natural gas according to embodiments of the present invention can be provided on a marine structure such as the aforementioned LNG RV and LNG FRSU as well as a marine or overland regasification facility, if an LNG regasification facility is provided. Further, the apparatus for reducing heating value of natural gas according to embodiments of the present invention can be provided on another marine structure in addition to the marine structure such as the aforementioned LNG RV and LNG FSRU.

In general, when natural gas is extracted from a gas well, the LPG component having high heating value is separated from the LNG component having low heating value, and the LPG component and the LNG component are transferred separately. The apparatus for reducing heating value of natural gas according to embodiments of the present invention can be used in order to additionally reduce heating value of the LNG component which is separately transferred. Further, the inventors developed a method to liquefy and transfer both the LPG component and the LNG component together when natural gas is extracted from a gas well. Such method is disclosed in U.S. patent application Ser. No. 12/163,742 and Korean Patent Application No. 10-2009-10792 and the like. It will be apparent that the apparatus for reducing heating value of natural gas according to embodiments of the present invention can be applied in case that both the LPG component and the LNG component are liquefied and transferred together.

According to embodiments of the present invention as described above, in order to reduce heating value of natural gas consisting of various hydrocarbon components according to a requirement or demand of the markets, there may be provided a method and apparatus for reducing heating value of natural gas, which can separate partially components having high heating value using a small-sized separator requiring an inexpensive installation and operation expense.

According to embodiments of the present invention, as a result, there is no need to provide an expensive and large-sized distillation column or nitrogen generating facility, so that an initial investment and operating expense can be reduced.

In addition, according to embodiments of the present invention, a ratio of nitrogen in the components of gas supplied to the markets is not excessively increased and the amount of nitrogen consumed is reduced, whereby an operation expense of the facility operating on the sea, on which a demand and supply of nitrogen are not maintained stably, can be reduced.

Although a structure of a storage tank for the floating marine structure according to embodiments of the present invention has been described with reference to the drawing, the present invention is not limited to the embodiment and drawing illustrated above. It will be apparent that those skilled in the art can make various modifications and changes thereto within the scope of the invention defined by the claims.

What is claimed is:

1. An apparatus for reducing heating value of natural gas, comprising:
a heating means for heating liquefied natural gas (LNG); and
a gas-liquid separating means for separating the LNG heated and partially gasified by the heating means into a gaseous component having low heating value and a liquid component having high heating value.

2. The apparatus as claimed in claim 1, wherein the heating means is at least one of a heater and a heat exchanger.

3. The apparatus as claimed in claim 2, wherein a heat source for heating the LNG in the heat exchanger is supplied from the gas component separated in the gas-liquid separating means.

4. An LNG heating value adjustment system comprising:
an LNG tank containing liquefied natural gas (LNG), the LNG tank comprising an LNG tank outlet and an LNG tank inlet;
a conduit connected to the outlet of the LNG tank and configured to flow LNG from the LNG tank therethrough;
a heater configured to heat the LNG flowing through the conduit to a predetermined temperature to boil off some of the LNG boils to form a mixture of gaseous components and liquid components; and
a gas-liquid separator, which is not a distillation column, comprising an enclosed space, a gas outlet and a liquid outlet:
to receive the mixture from the conduit, wherein a phase separation occurs between the liquid components and gaseous components as the mixture enters the enclosed space of the gas-liquid separator,
to discharge the gaseous components via the gas outlet, and
to discharge the liquid components via the liquid outlet.

5. The system of claim 4, wherein the liquid outlet is connected to the LNG tank directly or indirectly such that all or some of the liquid components are returned to the LNG tank.

6. The system of claim 4, wherein the conduit is configured to continuously flow the LNG, wherein the gas-liquid separator is configured to continuously receive the mixture and to continuously discharge the gaseous components and liquid components.

7. The system of claim 4, further comprising:
a pre-heater located upstream the heater in the conduit, the pre-heater being configured to pre-heat the LNG using heat from the gaseous components discharged from the gas-liquid separator.

8. The system of claim 4, further comprising:
a distillation column configured to receive all or some of the liquid components from the gas-liquid separator and to separate one or more components therefrom.

9. The system of claim 4, further comprising:
another LNG tank configured to receive all or some of the liquid components discharged from the gas-liquid separator.

10. A floating structure comprising the system of claim 4.

11. A method of adjusting a heating value of LNG, the method comprising:
providing an LNG tank containing liquefied natural gas (LNG);
discharging LNG from the LNG tank and flowing through a conduit;
heating the LNG flowing through a conduit to a predetermined temperature to boil off some of the LNG so as to form a mixture of liquid components and gaseous components;
supplying the mixture into a gas-liquid separator comprising an enclosed space, which is not a distillation column, wherein a phase separation occurs between the liquid components and gaseous components as the mixture enters the enclosed space of the gas-liquid separator;
discharging the gaseous components from the gas-liquid separator; and
discharging the liquid components from the gas-liquid separator.

12. The method of claim 11, further comprising returning all or some of the liquid components to the LNG tank, whereby a heating value of the LNG contained in the LNG tank is adjusted.

13. The method of claim 11, further comprising collecting all or some of the liquid components in another LNG tank.

14. The method of claim 11, further comprising:
continuously supplying all or some of the liquid components to a distillation column for separating one or more components therefrom.

15. The method of claim 11, further comprising:
pre-heating the LNG flowing through the conduit using heat from the gaseous components discharged from the gas-liquid separator.

16. The method of claim 11, wherein LNG is continuously discharged from the LNG tank and continuously flown through the conduit.

17. The method of claim 11, wherein the mixture is continuously supplied into the gas-liquid separator, wherein the gaseous components are continuously discharged from the gas-liquid separator, and wherein the liquid components are continuously discharged from the gas-liquid separator.

18. The method of claim 11, further comprising collecting the gaseous components in a natural gas (NG) container.

19. The method of claim 11, wherein the method is performed on board in a ship.

20. The method of claim 11, wherein the method is performed on an off-shore floating structure or an on-shore facility.
